(19) United States
(12) Patent Application Publication
(10) Pub. No.: US 2010/0074321 A1
(43) Pub. Date: Mar. 25, 2010

(54) ADAPTIVE IMAGE COMPRESSION USING PREDEFINED MODELS

(75) Inventor: SCOTT BEAUDREAU, REDMOND, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/238,319

(22) Filed: Sep. 25, 2008

(51) Int. Cl. H04N 7/12

(52) U.S. Cl. 375/240.01; 375/E07.076

(57) ABSTRACT

Systems, methods and computer readable media for preparing an image or video file for compression are disclosed. An original image and a predefined visibility model are provided to a compression engine. The visibility model depicts a visual display, such as a web page, in which the image will be presented including the spatial and temporal layout, any elements of the display that overlap the image, or transformations of the image, among others. The compression engine determines regions of the original image that are at least partially occluded when the visibility model is applied. The compression engine then determines a regional compression or schemes to be applied to each region and applies those schemes to produce a prepared image. The prepared image has a reduced file size as compared to the original image and can be presented to a compression, or codec, for further compression.

### BACKGROUND

Image and video files are very common and very popular in today's computing world. Millions of image files are transferred every minute over the internet between computers, web servers, and media servers, among others. Often, image files are very large and consume a great deal of memory and bandwidth as they are transferred. This can slow the transfer of the image file and the network as a whole. As a result many different techniques and compressions have been developed to compress image files and reduce their file size in order to make transfer of the files easier and less consuming of internet resources.

Compression software, or algorithms, often called codecs, utilize a variety of sophisticated methods to compress the data of an image file. In a general sense, the methods find ways to cut some of the image data or reorganize it such that the overall file size is smaller. This may require cutting portions of the image, decreasing the color spectrum of the image, reorganizing image data, or more sophisticated techniques utilizing adaptive frame rates, adaptive quality and adaptive motion processing approaches.

### BRIEF SUMMARY

Embodiments of the present invention relate to systems, methods and computer readable media for decreasing the file size of an image prior to applying a compression software. A compression engine utilizes a visibility model applied to an original image to identify one or more regions of the original image that will be at least partially occluded when the original image is rendered. The compression engine compresses the one or more regions to produce a prepared image which has a smaller file size than the original image. A compression is then utilized to compress the prepared image.

Additional objects, advantages, and novel features of the invention will be set forth in part in the description which follows, and in part will become apparent to those skilled in the art upon examination of the following, or may be learned by practice of the invention.

### BRIEF DESCRIPTION OF THE SEVERAL VIEWS OF THE DRAWING

The present invention is described in detail below with reference to the attached drawing figures, wherein:

FIG. 1 is a block diagram of an exemplary computing environment suitable for use in implementing embodiments of the present invention;

FIG. 2 is a flow diagram illustrating methods for decreasing the file size of an image prior to applying a compression according to an embodiment of the present invention;

FIG. 3 is a flow diagram illustrating methods for preparing an image for compression according to an embodiment of the present invention;

FIG. 4 is an illustrative screen display depicting a webpage having a partially occluded image according to an embodiment of the present invention;

FIG. 5 is an graphical representation of a visibility model according to an embodiment of the present invention;

FIG. 6 is a graphical representation of a prepared image according to an embodiment of the present invention;

FIG. 7 is an illustrative screen display depicting a webpage having a partially occluded image according to an embodiment of the present invention; and

FIG. 8 is an illustrative screen display depicting a prepared image according to an embodiment of the present invention.

### DETAILED DESCRIPTION

Embodiments of the present invention provide systems, methods and computer readable media for decreasing the file size of an image prior to applying a compression. In one aspect, a computerized method for decreasing the file size of an image prior to applying a compression is provided. A compression engine receives an original image and a visibility model. The compression engine identifies one or more regions of the original image that are at least partially occluded by one or more fields depicted by the visibility model and compresses those regions to produce a prepared image having a smaller file size than the original image. The prepared image may then be compressed.

In another aspect, a computerized system for decreasing the file size of an image is provided. A receiving component configured for receiving an original image, and a visibility model depicting one or more regions of the original image that may be compressed due to one of spatial and temporal visibility of the original image is provided. A utilizing component configured for utilizing the visibility model to determine one or more regions of the original image that may be compressed and a first compressing component configured for compressing the one or more regions of the original image utilizing one of a codec, compression algorithm and an adaptive compression to produce a prepared image having a smaller file size than the original image are also disclosed. Further, a second compressing component configured for compressing the prepared image is presented.

In yet another aspect of the present invention, one or more computer readable media having computer-executable instructions embodied thereon that, when executed, perform a method for preparing an image for compression is provided. An original image and a visibility model are received by a compression engine. The visibility model depicts the visibility of an associated image both spatially and temporally. The visibility model is applied to the original image to identify one or more regions of the original image that are at least partially occluded by one or more portions depicted by the visibility model. One or more compressions are determined for application to the identified regions. The one or more compressions are applied to the one or more identified regions to produce a prepared image which has a smaller file size than the original image. The prepared image is then compressed, if such is desired.

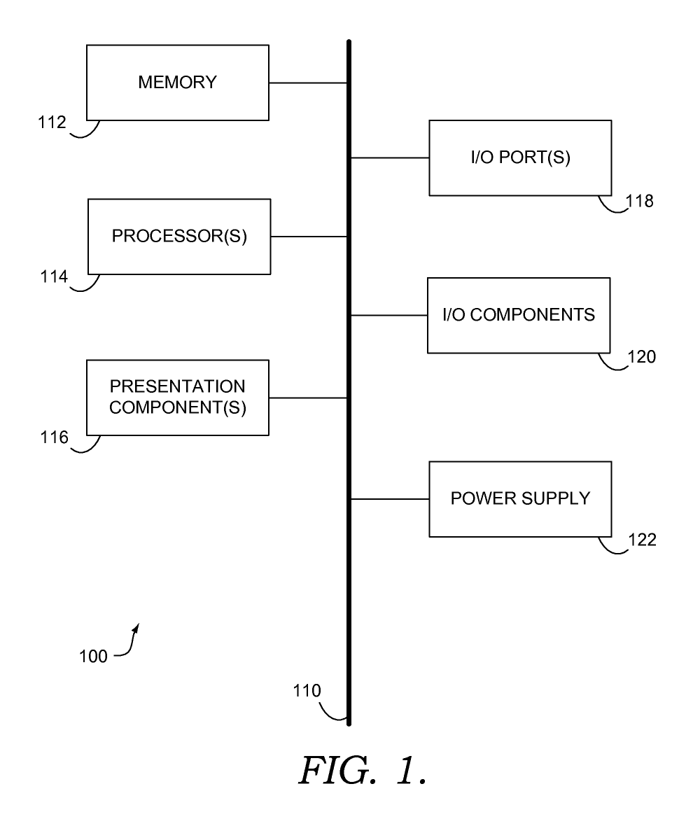

Referring initially to FIG. 1 in particular, an exemplary operating environment for implementing the present invention is shown and designated generally as computing device 100. Computing device 100 is but one example of a suitable computing environment and is not intended to suggest any limitation as to the scope of use or functionality of the invention. Neither should the computing-environment 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would be more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. By way of example, and not limitation, computer-readable media may comprises Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by the computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. The computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow the computing device 100 to be logically coupled to other devices including I/O components 120, some of which may be built in. Illustrative components include a microphone, joystick, game pad, satellite dish, scanner, printer, wireless device, etc.

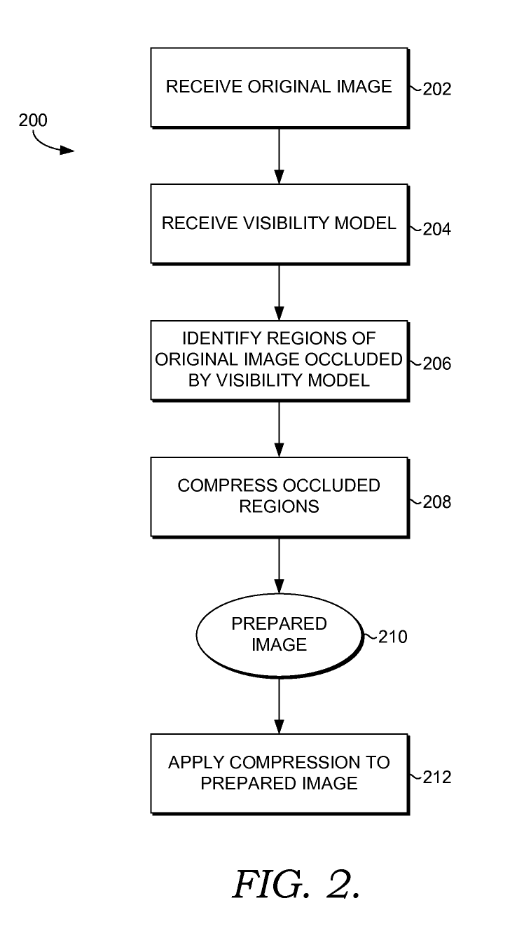

Referring now to FIG. 2 a method 200 for decreasing the file size of an image prior to applying a compression software is described according to an embodiment of the present invention. Initially, an original image is received by compression engine on a computing device 100 at step 202. The original image is any electronic image or video file available in the art including, but not limited to, photographs, drawings, renderings, videos, and movies, and may be in any file format useable by the compression engine, such as JPEG, TIFF, PDF, MPEG, and MOV, among many others.

The compression engine also receives a visibility model at step 204. The visibility model provides a description of the webpage or display in which the original image is to be rendered following preparation by the method 200. The description may include any characteristics of the webpage that are necessary to determine how the original image may be compressed or manipulated in the subsequent steps of the method 200. Such characteristics may include the size of the image as rendered, the shape of a transformation that is to be applied to the image, any visual effects applied to the image, the size, shape, opacity and effects applied to other regions on the webpage that overlap portions of the image, and temporal and spatial descriptions of any moving objects or regions, among others. The visibility model will be discussed further, and in greater detail with respect to FIG. 5 below.

The method 200 continues at block 206, at which the compression engine identifies regions of the original image that will be at least partially occluded from view when the image is rendered following the visibility model. The identified regions are then compressed at step 208 to produce a prepared image 210 having a smaller file size than the original image. At step 212 a compression is applied to the prepared image to further reduce the file size.

The compression at step 208 is distinctly different from the compression of step 212. In step 208 one or more regional compressions, are utilized by the compression engine along with the information provided by the visibility model, regarding the identified at least partially occluded regions of step 206. The terms compression, compression scheme, compression algorithm, and compression system are used interchangeably herein, the additional descriptor “regional” referring to their application to an identified region, rather than to an image as a whole. The regional compressions allow the compression engine to remove and simplify, among other processes, image data from the identified regions. Many options exist which enable the removal of image data including cropping, clipping, or cutting portions of the image that are completely occluded, or other, more sophisticated techniques, such as adaptive compression, among others, in instances of partial occlusion. Such techniques may include reducing the number of colors or ghosting out colors, using larger blocks of pixels rather than individual pixels, or reducing the motion or change seen by pixels (where the image is part of a video), among others. Further, the regional compressions may use, or be referred to as a lossy compression in which data is removed permanently.

These regional compressions are applied only to the identified regions of the original image and not to the image as a whole. Further, one or more regional compression schemes may be applied to a single region and different regional compression schemes may be applied to different regions within the visibility model. Additionally, the regional compressions may be chosen with knowledge of the compression system that will be applied in step 212 such that the regional compression or compressions enhance the ability of the compression system to compress the image. For example, where a compression operates on an algorithm that decreases color density of an image, a regional compression may be chosen to reduce the color density in a way that is beneficial to the operation of the compression algorithm.

Conversely, the compression of step 212 comprises any compression software, codec, algorithm, or other compression method available in the art to compress the entire prepared image. The compressions in the art are typically applied with no knowledge of the final rendering of the image other than the assumption that the image should be rendered at or near its original quality. Further, when rendering an image in a webpage, the compression steps taken by the compression of step 212 must typically be reversed to return the image to original, or nearly original quality. In contrast, the regional compressions applied by the compression engine in the method 200 are not reversed. The image is rendered in the webpage with the compressed regions remaining compressed.

An additional distinction is noted in that many compression systems assume a common, typically rectangular display format for an image, and do not take into account the manner or layout in which the image will be displayed. Often times an image will be rendered having visual transformations that reduce the visible area of the image. For example, a typical rectangular image might be rendered subject to a transform, such that only a smaller oval portion of the image is visible to a user, or a visual alteration might be applied to the rendered image giving it the effect of fading into the page, among various other effects. In such a case, the portion of the image that is occluded from view or that is difficult to see due to a visual alteration is wasted data that is not necessary for viewing the image as rendered and need not be transferred over the network. Transferring the wasted data increases the necessary transfer time, file size, network bandwidth consumed, and the rendering time, among other things. By method 200, much, if not all, of this wasted data can be removed from the image.

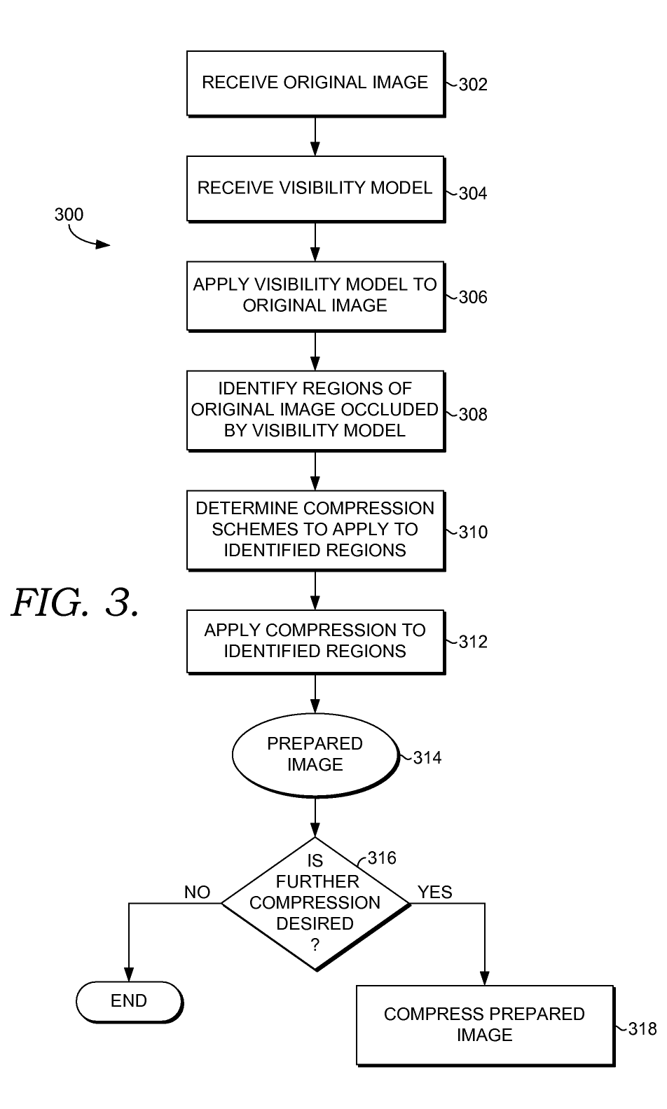

With reference now to FIG. 3, a method 300 for preparing an image for compression is described according to another embodiment of the present invention. An original image is received at a compression engine at block 302 followed by receipt of a visibility model at block 304. The visibility model is then applied to the original image at step 306 and one or more regions of the original image that are shown by the visibility model to be at least partially occluded are identified at step 308. The compression engine determines one or more regional compressions for application to the identified regions at step 310 and applies those schemes at step 312. A resulting prepared image 314 may then be fully compressed at step 318 if such a choice is made at option block 316.

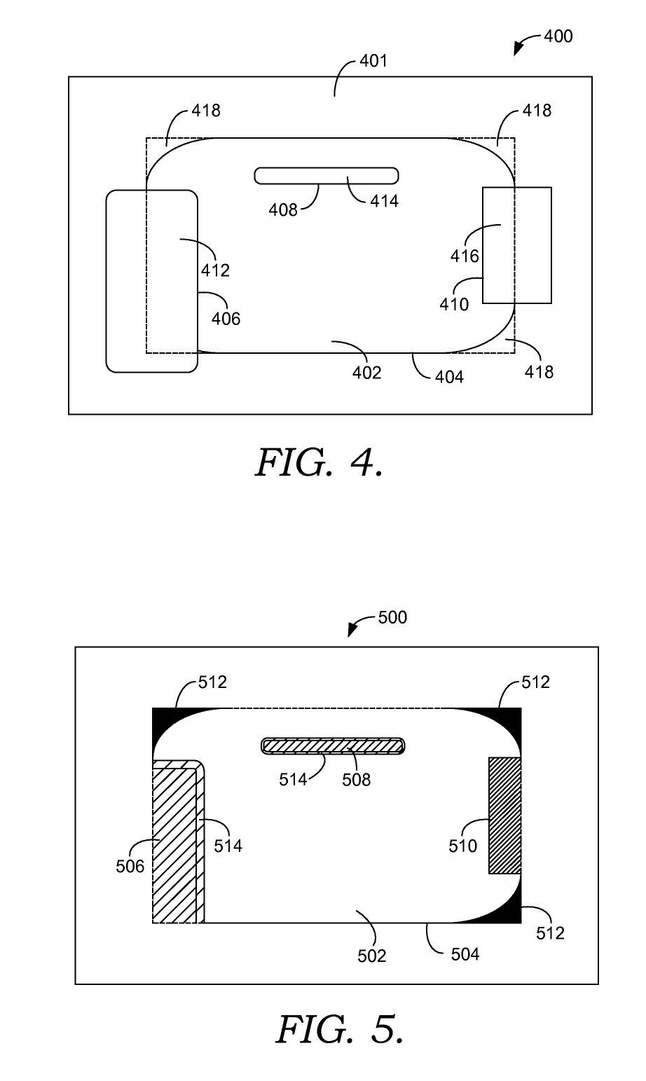

With reference now to FIGS. 4, 5 and 6, the systems, methods and computer readable media of the present invention may be described with respect to a possible layout of a webpage in which an image is to be rendered according to an embodiment of the present invention. In describing the invention with respect to the figures it is advantageous to visualize a webpage, or display, as a layered object having a depth in the z direction, going into the page. Therefore objects or elements said to be on top or in front of others are commonly said to be higher in the z-order while those behind are lower in z-order.

FIG. 4 depicts an illustrative screen display of a webpage 400 having a webpage body 401, an image field 402, a transform outline 404, a high transparency field 406, a low transparency field 408, and an opaque field 410. The layout, quantity, and qualities of these elements are described for illustrative purposes only and are not meant to restrict the scope of the present invention. One skilled in the art would find innumerable other layouts, quantities, and qualities for the elements, all of which are considered within the scope of this description.

The webpage 400 comprises any webpage available in the art and may also include any other form of electronic display in which an image is rendered. The webpage body 401 encompasses the entire area of the webpage 400, with the lowest z-order position, on which all other elements are placed, rendered, or otherwise displayed. The image field 402 depicts the area of the webpage 400 in which an image is to be rendered and is delineated by the transform outline 404 which represents the shape of a transformation applied to an image.

The high transparency field 406 is illustrated along, and overlapping, the left side of the image field 402. The high transparency field 406 is illustrative of any graphic, field, or other object on a webpage 400, with or without any artifacts such as text or drawings, among others, located therein, and which has a nearly transparent background that allows an underlying image to at least partially show through. The low transparency field 408 is shown near the top of the image field 402 and higher in z-order such that it overlays the image field. Like the high transparency field 406, the low transparency field 408 is illustrative of any graphic, field, or other object on a webpage 400, with or without any artifacts such as text, or drawings, among others located therein, but has a background that is nearly opaque, thereby greatly reducing the visibility of an underlying image. The opaque field 410 is illustrated along and overlapping the right side of the image field 402 and has the same properties as the high and low transparency fields 406, 408 except that its background is fully opaque and an underlying image is not visible through the background.

With continued reference to FIG. 4, within the high transparency field 406, low transparency field 408 and opaque field 410 are located a mild compression region 412, a moderate compression region 414, and a strong compression region 416 respectively. These regions 412, 414, and 416 indicate regions of an underlying image within the image field 402 that may be compressed by a compression engine and regional compression as described above, due to reduced visibility of the image. Additionally, the amount of compression that may be applied to each region is shown to be a factor of the level of visibility of an image through a given region. For example, the portion of an image located in the mild compression region 412 can only be mildly compressed because the image will show through the high transparency field 406 and a user will notice a large change in the quality of the image. In contrast, the region of an image in the moderate compression region 414 may be compressed to a greater extent because the visibility of the region through the low transparency field 408 will be low, and a user will not be able to visually detect a larger drop in image quality. Further, a great deal of compression, up to and including cropping of the image may be applied in the strong compression region 416, because a user will not be able to see the image through the opaque field 410. Further, one or more cropped regions 418 are depicted in FIG. 4 showing regions of an image that are not visible to a user in the webpage 400 due to the application of a transformation, and that may be cropped, cut or otherwise deleted from the image data.

In other embodiments, the degree of compression applied to each region may be determined by a user creating a webpage or visibility model, and may, or may not be a factor of the level of transparency of an overlying field. Such a determination may be made based on an intended aesthetic appearance or other considerations.

Looking now to FIG. 5 a visibility model 500 is depicted according to an embodiment of the present invention. The visibility model 500 has many features that coincide with those displayed in webpage 400 in FIG. 4 including, an image field 502, a transform outline 504, a mild compression region 506, a moderate compression region 508, a strong compression region 510, and one or more cropped regions 512. The visibility model 500 describes all aspects of the form in which an image will be rendered in a webpage or display that are necessary for a compression engine to determine regions of the image that may be compressed and to what extent.

The image field 502 depicts the regions of an image that should not be compressed because they will be fully visible to a user. The transform outline 504 delineates a transform applied to the image to alter the overall shape of the image. For example, FIG. 4 depicts a transformation in which the corners of an originally rectangular image will be hidden from view to make the image appear within a semi-oval shape. Other transformations might utilize a circular, triangular, star, or other shape for an image presentation.

Additionally, regions in which an image may be compressed are denoted by mild compression region 506, moderate compression region 508, and strong compression region 510. As described previously, the degree of compression available in each of these regions is a factor of the visibility of the image through fields that overlay the regions. One or more cropped regions 512 are also depicted where the transform outline 504 crosses within portions of an image, shown in FIG. 4 at three corners of the image. These cropped regions 512 may be cropped or otherwise cut from the image data.

The visibility model 500 is most easily viewed and described pictorially as shown in FIG. 5, but may also be described having an associated list, or comprising only a list of regions including, for example, the image field 502, mild compression region 506, moderate compression region 508, strong compression region 510, cropped regions 512, and boundary regions 514. The list may include descriptions or metadata about the regions indicating their shape, location, identification, temporal data depicting changes in the region with time (where such is the case), and data corresponding to any regional compressions, color transformations, opacity transformations, geometric transformations, and visibility factors, among others.

Further, the visibility model may rank the regions in the list according to importance, benefit, efficiency, and time to compress among others, such that the utilization of regional compressions by the compression engine may be tailored to a given application. This allows the compression engine to apply regional compressions to more or fewer regions based on factors such as computing speed, required file size reductions, and available network bandwidth, among others.

To describe the shape of regions such as those depicted in FIGS. 4 and 5 shape primitives, such as triangles, ovals or rectangles, among others, or a vector paths comprising a set of vectors which return to an initial vector to enclose a shape, might be used. To describe more complex regions combinations, unions, intersections and subtractions of multiple shape primitives and vector paths may be utilized.

With continued reference to FIG. 5 boundary regions 514 are depicted around the mild compression region 506 and the moderate compression region 508. The boundary regions 514 may also be included around any region or element on a webpage and may fully surround or only partially surround that region or element. The boundary region 514 provides an area around regions compressed by a compression engine that has a gradient or other transition from a given compression region to an uncompressed image field 502. Doing so provides a tolerance area for applications where a webpage may not render fields overlaying an image in the exact same position every time. Thus, the boundary region 514 allows for a small amount of movement or misplacement of an overlying field without revealing compressed regions of the image in full view of a user.

For example, if the webpage 400 of FIG. 4 was rendered with the opaque field 410 three millimeters lower than usual for some unknown reason, then a portion of the strong compression region 416 may be visible to a user and may appear as a black box or line if the pixels of the underlying image had been set to black by the compression engine. On the other hand, if the moderate compression region 414 of FIG. 4 were rendered three millimeters lower than expected a user may not notice because a boundary region 514 as depicted in FIG. 5 provides a transition or tolerance around the more compressed moderate compression region 508.

Additionally, a boundary region 514 may provide a needed tolerance around compression regions that move across a webpage with a moving overlying field. Such compression regions may be more difficult to model in a visibility model and may be more difficult for a computing device 100 to process quickly. Thus, there may be some lag time between the movement of a field and the rendering of an underlying image which could cause a compression region to become visible to a user. Applying a boundary region 514 would aid in decreasing the visibility of highly compressed areas is such cases.

To utilize a visibility model to identify and compress regions of an original image the visibility model must be predefined. The intended webpage, display or other presentation layout (hereinafter “webpage”) must be known and a visibility model constructed for that webpage. This may be completed ahead of time and a single static visibility model utilized for one or more webpages or a dynamic visibility model may be created. A dynamic visibility model still requires prior knowledge of the intended webpage layout, but the knowledge may be obtained through constant or intermittent communication with a user's computing device. Such communication must allow a server or computing device to track changes to the webpage layout and to adjust the visibility model to account for the changes. In either a static or dynamic instance, a library of visibility models may be stored on a server, a user's computing device, or other computing system with access to a network, and each visibility model given an identification code or name such as a global unique identification (GUID), among others. This would allow a server to identify and obtain an appropriate visibility model for a given webpage.

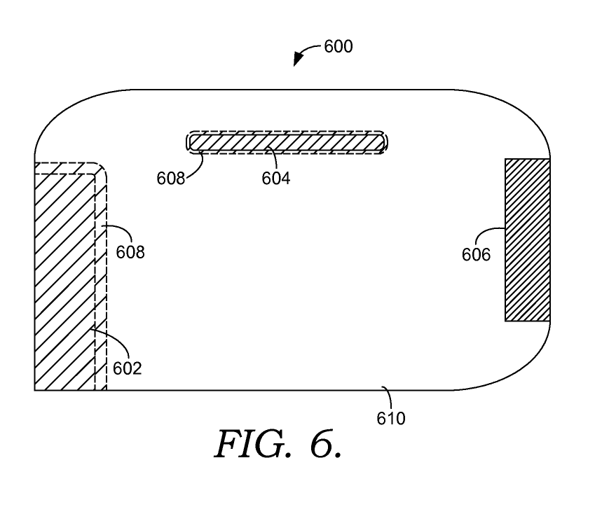

Moving now to FIG. 6, a graphical representation of a prepared image 600 that may be produced from application of the visibility model 500 to a rectangular image, is depicted according to an embodiment of the present invention. The prepared image contains a mild compression region 602, a moderate compression region 604, and a strong compression region 606. A boundary region 608 is found associated with both the mild compression region 602 and the moderate compression region 604. A visible area 610 comprises the remainder of the prepared image and is not subjected to compression by a compression engine.

As shown in FIG. 6, the originally rectangular image has been cropped along the top and bottom right corners. Additionally, regional compressions have been applied to the mild compression region 602, moderate compression region 604, strong compression region 606 and boundary regions 608 by a compression engine. Through the use of regional compressions and cropping of the image, the image data for those regions has been reduced, or completely deleted from the image file, thereby decreasing the overall file size of the image file. Thus, the prepared image 600 has a smaller file size than the original image. The degree to which the file size can be reduced is dependent on many factors including, for example, the level of compression that is applied to the regions, and the size of the regions, among others.

The prepared image 600, having a reduced file size as compared to its original form may be stored or may be communicated to a compression system to further compress the entire image file. From either point, the prepared image 600 may eventually be communicated to a user's computing device 100 on which, the prepared image may be rendered in a webpage, such as webpage 400. Ideally, a user will not notice any visual difference between a webpage rendering the prepared image 600 or the original form of the prepared image.

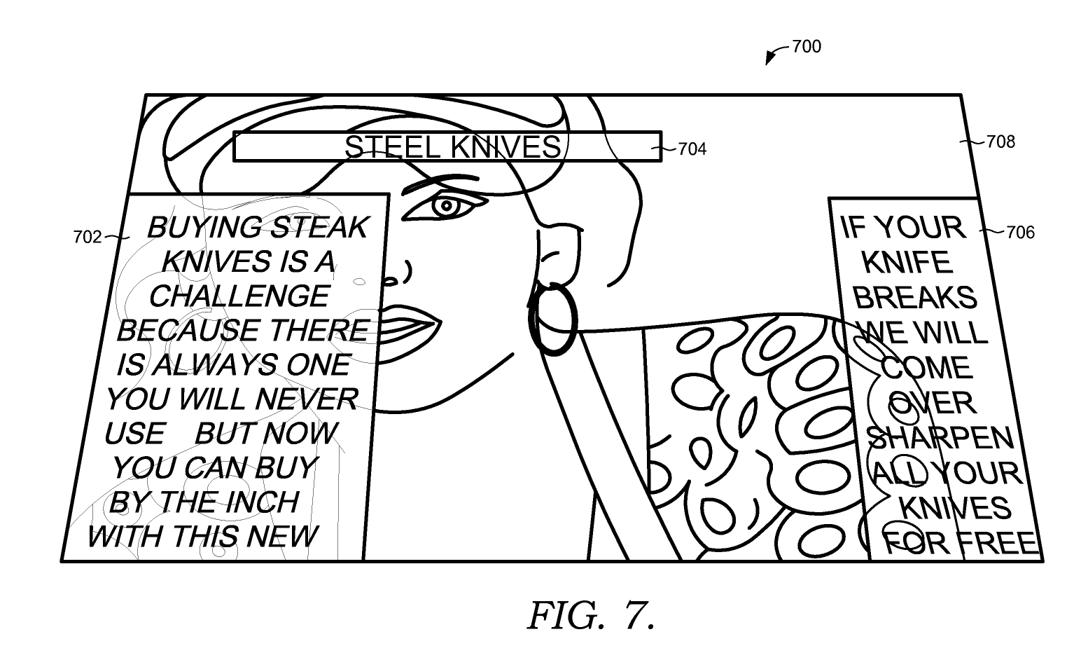

Referring now to FIG. 7, a webpage 700 is depicted according to another embodiment of the present invention. The webpage 700 contains a low transparency field 702, a moderate transparency field 704 and a high transparency field 706, each of which having text contained therein. The remainder of webpage 700 depicts an uncompressed image field, wherein a prepared image is displayed in original form. Within the low transparency field 702, and behind the text therein, the image can be seen, but only lightly due to the opacity of the low transparency field obstructing the view of the underlying image. The text within the low transparency field is also easily readable due to the contrast with the background of the low transparency field 702 and the muting of the underlying image. The underlying image is slightly more visible in the moderate transparency field 704, and even more so in the high transparency field 706.

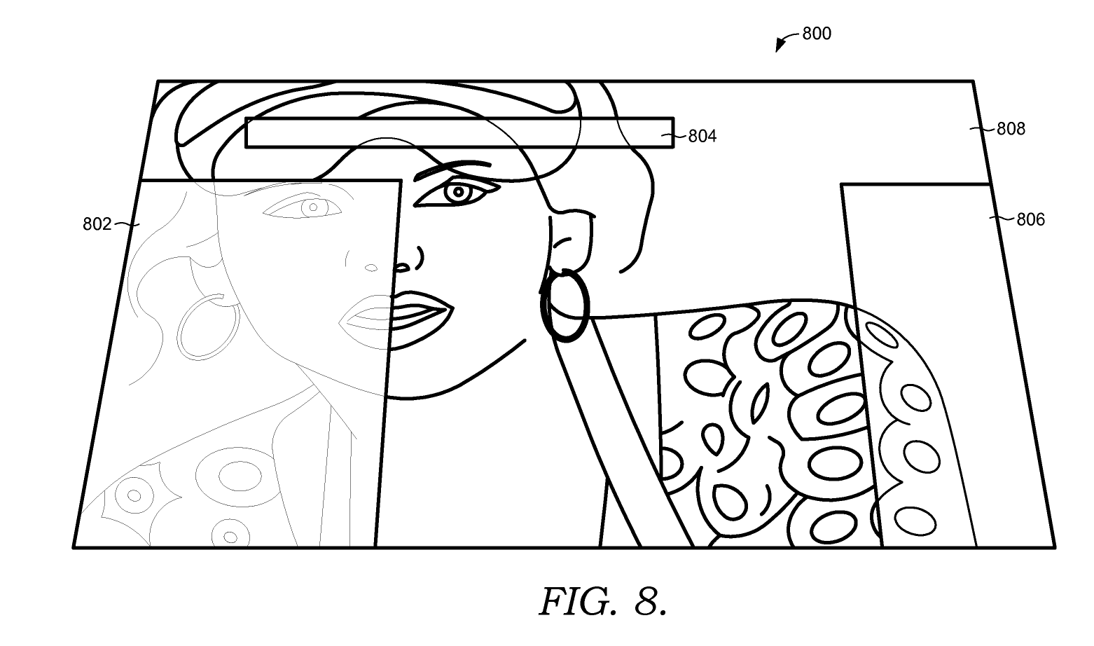

With reference now to FIG. 8, a prepared image 800 that may be utilized in rendering the webpage 700 is depicted according to an embodiment of the present invention. The prepared image comprises a strong compression region 802, a moderate compression region 804, and a mild compression region 806 as well as an uncompressed region 808. The degree of compression of the regions 802, 804, and 806 is determined based on the degree of transparency of the overlying low transparency field 702, moderate transparency field 704, and high transparency field 706 of webpage 700, respectively. For example, the strong compression region 802 is strongly compressed, because the image in this region will be only partially visible through the low transparency field 702, and therefore, a user will not easily perceive a larger drop in image quality. The moderate compression region 804 and the mild compression region 806 compressed to a lesser degree, because a user will more readily perceive a quality drop in these regions due to the increased transparency of the overlying fields 704 and 706, respectively.

From the foregoing, it will be seen that this invention is one well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative and not in a limiting sense.

1. A computerized method for decreasing the file size of an image prior to applying a compression comprising the steps:
receiving an original image at a compression engine;
receiving a visibility model at the compression engine;
identifying one or more regions of the original image that are at least partially occluded by one or more fields depicted by the visibility model;
compressing the one or more identified regions to produce a prepared image, wherein the prepared image has a smaller file size that the original image; and
compressing the prepared image.

2. The computerized method of claim 1, wherein the original image is one of a plurality of images that comprise a video, and wherein, the method is applied to the plurality of images to produce a prepared video with a smaller file size than an original video.

3. The computerized method of claim 1, wherein the visibility model comprises a list describing one or more regions of a visual display.

4. The computerized method of claim 3 wherein, the one or more regions described in the list are ranked by one or more of: compression benefit, efficiency, importance and time.

5. The computerized method of claim 3, wherein the one or more regions are defined by one or more of: a shape primitive, a vector path and one or more of a combination, union, intersection and subtraction of one or more shape primitives and vector paths.

6. The computerized method of claim 3, wherein the description of the one or more regions includes metadata for each of the one or more regions comprising one or more of: identification, shape, location, color transform, opacity transform, geometric transform, image quality requirement, visibility, and temporal visibility.

7. The computerized method of claim 1, wherein one or more regional compressions are chosen to compress the one or more regions and wherein the one or more regional compressions are chosen with knowledge of a prepared image compression.

8. The computerized method of claim 7, wherein the one or more regional compressions comprise one or more of: cropping, clipping, cutting, adaptive compression, setting a color of pixels, and applying a codec.

9. The computerized method of claim 1, wherein the visibility model is dynamic and changes with respect to one of: time and use.

10. The computerized method of claim 1, wherein an identifier comprising one of: a metatag, a file name, and a global unique identifier (GUID) is associated with the visibility model.

11. A computerized system for decreasing the file size of an image, the system comprising:
a receiving component configured for receiving an original image and a visibility model depicting one or more regions of the original image that may be compressed due to one of spatial and temporal visibility of the original image;
a utilizing component configured for utilizing the visibility model to determine one or more regions of the original image that may be compressed;
a first compressing component configured for compressing the one or more regions of the original image utilizing one of a codec, compression algorithm and an adaptive compression to produce a prepared image having a smaller file size than the original image; and
a second compressing component configured for compressing the prepared image.

12. The computerized system of claim 11, wherein the original image is one of a plurality of images that comprise a video, and wherein, the system is applied to the plurality of images to produce a prepared video with a smaller file size than an original video.

13. The computerized system of claim 11, wherein the visibility model comprises a list describing one or more regions of a visual display.

14. The computerized system of claim 13, wherein the one or more regions are defined by one or more of: a shape primitive, a vector path, and one or more of a combination, union, intersection and subtraction of one or more shape primitives and vector paths.

15. The computerized system of claim 13, wherein the description of the one or more regions includes metadata for each of the one or more regions comprising data regarding one or more of: identification, shape, location, color transformation, opacity transformation, geometric transformation, image quality requirement, visibility, and temporal visibility.

16. The computerized system of claim 11, wherein the compression utilized by the first compressing component to compress the one or more regions, is chosen with respect to the compression utilized by the second compressing component, in order to enhance the compression of the prepared image.

17. The computerized system of claim 16, wherein the compression utilized by the first compressing component comprises one or more of: cropping, clipping, cutting, adaptive compression, setting a color of pixels, and a codec.

18. The computerized system of claim 11, wherein the visibility model is dynamic and changes with respect to one of: time and use.

19. The computerized system of claim 11, wherein the compression utilized by the second compressing component is a codec.

20. One or more computer readable media having computer-executable instructions embodied thereon that, when executed perform a method for preparing an image for compression comprising the steps:
receiving an original image at a compression engine;
receiving a visibility model at a compression engine, wherein the visibility model depicts the spatial and temporal visibility of an associated image in a visual display;
applying the visibility model to the original image;
identifying one or more regions of the original image that are at least partially occluded by one or more portions depicted by the visibility model;
determining one or more compressions to apply to the one or more identified regions;
applying the one or more compressions to the one or more identified regions to produce a prepared image, wherein the prepared image has a smaller file size than the original image; and
compressing the prepared image if desired.
